(19) United States
(12) Patent Application Publication
(10) Pub. No.: US 2007/0129945 A1
(43) Pub. Date: Jun. 7, 2007

(54) Voice quality control for high quality speech reconstruction

(76) Inventors: Changxue C. Ma, Barrington, IL (US); Yan M. Cheng, Inverness, IL (US); Steven J. Nowlan, South Barrington, IL (US); Tenkasi V. Ramabadran, Naperville, IL (US)

Correspondence Address: MOTOROLA, INC., 1303 EAST ALGONQUIN ROAD, IL01/3RD, SCHAUMBURG, IL, 60196, US

(21) Appl. No.: 11/294,959

(22) Filed: Dec. 6, 2005

(51) Int. Cl. G10L 15/04

(52) U.S. Cl. 704/254

(57) ABSTRACT

A method and apparatus are provided for reproducing a speech sequence of a user through a communication device of the user. The method includes the steps of detecting a speech sequence from the user through the communication device, recognizing a phoneme sequence within the detected speech sequence and forming a confidence level of each phoneme within the recognized phoneme sequence. The method further includes the steps of audibly reproducing the recognized phoneme sequence for the user through the communication device and gradually highlighting or degrading a voice quality of at least some phonemes of the recognized phoneme sequence based upon the formed confidence level of the at least some phonemes.

### FIELD OF THE INVENTION

The field of the invention relates to communication systems and more particularly to portable communication devices.

### BACKGROUND OF THE INVENTION

Portable communication devices, such as cellular telephones or personal digital assistants (PDAs), are generally known. Such devices may be used in any of a number of situations to establish voice calls or send text messages to other parties in virtually any place throughout the world.

Recent developments, such as the placement of voice calls by incorporating automatic speech recognition into the functionality of portable communication devices, have simplified the control of such devices. The use of such functionality has greatly reduced the tedious nature of entering numeric identifiers through a device interface.

Automatic speech recognition, however, is not without shortcomings. For example, the recognition of speech is based upon samples collected from many different users. Because recognition (e.g., using the Hidden Markov Model (HMM)) is based upon many different users, the recognition of speech from any one user is often subject to significant errors. In addition to errors due to the speech characteristics of the individual user, recognition errors can also be attributed to noisy environments and dialect differences.

In order to reduce unintended recognition actions due to speech recognition errors, portable devices are often programmed to audibly repeat a recognized sequence so that a user can correct any errors or confirm the intended action. When an error is detected, the user may be required to repeat the utterance or partial sentence.

In the case of some users, however, mispronounced words may not be properly recognized. In such cases, similarly sounding words may be recognized instead of the intended word. Where a word is not properly recognized, repeating a similarly sounding word may not put a user on notice that the word has not been properly recognized. Accordingly, a need exists for a better method of placing a user on notice that a voice sequence has not been properly recognized.

### BRIEF DESCRIPTION OF THE DRAWINGS

The present invention is illustrated by way of example and not limitation in the accompanying figures, in which like references indicate similar elements, and in which:

FIG. 1 is a block diagram of a communication device in accordance with an illustrated embodiment of the invention; and

FIG. 2 is a flow chart of method steps that may be used by the device of FIG. 1.

### DETAILED DESCRIPTION OF AN ILLUSTRATED EMBODIMENT

A method and apparatus are provided for recognizing and correcting a speech sequence of a user through a communication device of the user. The method includes the steps of detecting a speech sequence from the user through the communication device, recognizing a phoneme sequence within the detected speech sequence and forming a confidence level of each phoneme within the recognized phoneme sequence. The method further includes the steps of audibly reproducing the recognized phoneme sequence for the user through the communication device and gradually degrading or highlighting a voice quality of at least some phonemes of the recognized phoneme sequence based upon the formed confidence level of the at least some phonemes.

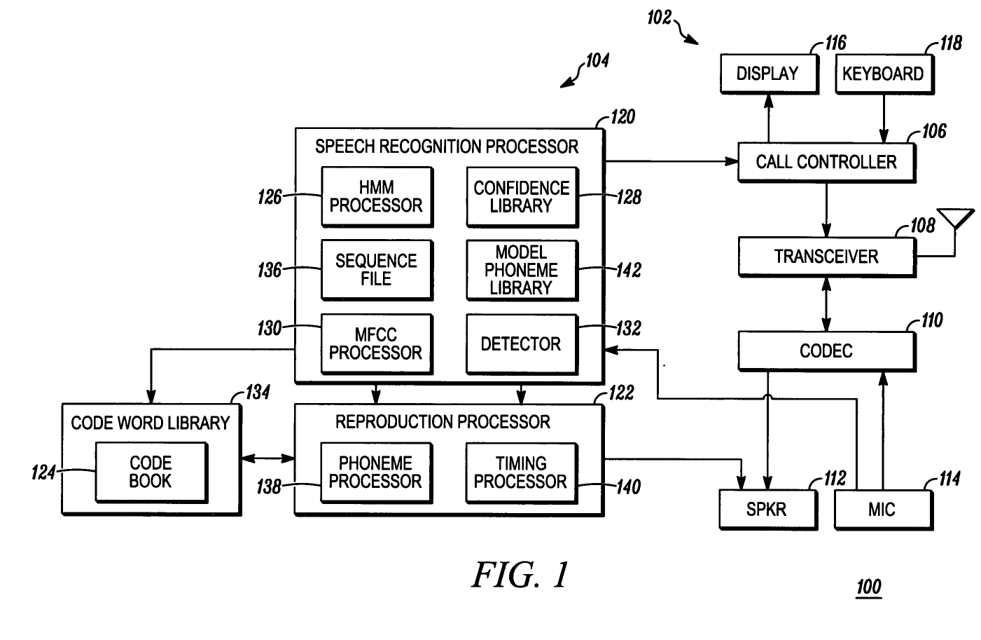

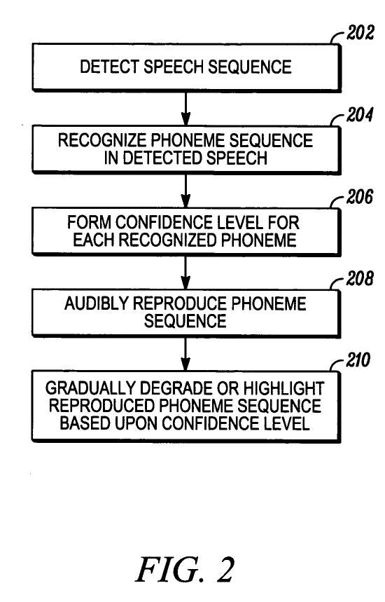

FIG. 1 shows a block diagram of a communication device 100 shown generally in accordance with an illustrated embodiment of the invention. FIG. 2 shows a set of method steps that may be used by the communication device 100. The communication device 100 may be a cellular telephone or a data communication device (e.g., a personal digital assistant (PDA), laptop computer, etc.) with a voice recognition interface.

Included within the communication device 100 may be a wireless interface 102 and a voice recognition system 104. In the case of a cellular telephone, the wireless interface 102 includes a transceiver 108, a coder/decoder (codec) 110, a call controller 106 and input/output (I/O) devices. The I/O devices may include a keyboard 118 and display 116 for placing and receiving calls, and a speaker 112 and microphone 114 to audibly converse with other parties through the wireless channel of the communication device 100.

The speech recognition system 104 may include a speech recognition processor 120 for recognizing speech (e.g., a telephone number) spoken through a microphone 114 and a reproduction processor 122 for reproducing the recognized speech through the speaker 112. A voice quality table (code book) 124 may be provided as a source of speech reproduced through the reproduction processor 122.

In general, a user of the communication device 100 may activate the communication device through the keyboard 118. In response, the communication device may prepare itself to accept a called number through the keyboard 118 or from the voice recognition system 104.

Where the called number is provided through the voice recognition system 104, the user may speak the number into the microphone 114. The voice recognition system 104 may recognize the sequence of numbers and repeat the numbers back to the user through the reproduction processor 122 and speaker 112. If the user decides that the reproduced number is correct, then the user may initiate the MAKE CALL button (or voice recognition command) and the call is completed conventionally.

Under illustrated embodiments of the invention, the voice recognition system 104 forms a confidence level for each recognized phoneme of each word (e.g., telephone number) and reproduces the phonemes (and words) based upon the confidence level. The word recognition system 104 intentionally degrades or highlights a voice quality level of the reproduced phonemes in direct proportion to the confidence level. In this way, the user is put on notice by the proportionately degraded or highlighted voice quality that one or more phonemes of a phoneme sequence may have been incorrectly recognized and can be corrected accordingly.

Referring now to FIG. 2, as each word is spoken into the microphone 114, the speech sequence/sound is detected within a detector 132 and sent to a Mel-Frequency Cepstral Coefficients (MFCC) processor 130 (at step 202). Within the MFCC processor 130, each frame of speech samples of the detected audio is converted into a set of observation vectors (e.g., MFCC vectors) at an appropriate frame rate (e.g., 10 ms/frame). During an initial start-up of the communication device 100, the MFCC processor 130 may provide observation vectors that are used to train a set of HMMs which characterize various speech sounds.

From the MFCC processor 130, each MFCC vector is sent to a HMM processor 126. Within the HMM processor 126, phonemes and words are recognized using a HMM process as typically known by individuals skilled in the art (at step 204). In this regard, a left-right HMM model with three states may be chosen over an ergodic model, since time and model states may be associated in a straightforward manner. A set of code words (e.g., 256) within a code book 124 may be used to characterize the detected speech. In this case, each code word may be defined by a particular set of MFCC vectors.

During use of the communication device 100, a vector quantizer may be used to map each MFCC vector into a discrete code book index (code word identifier). The mapping between continuous MFCC vectors of sampled speech and code book indices becomes a simple nearest neighbors computation, i.e., the continuous vector is assigned the index of the nearest (in a spectral distance sense) code book vector.

A unit matching system within the HMM processor 126 matches code words with phonemes. Training may be used in this regard to associate the code words derived from spoken words of the user with respective intended phonemes. In this regard, once the association has been made, a probability distribution of code words may be generated for each phoneme that relates combinations of code words with the intended spoken phonemes of the user. The probability of a code word indicates how probable it is that this code word would be used with this sound. The probability distribution of code words for each phoneme may be saved within a code word library 134.

The HMM processor 126 may also use lexical decoding. Lexical decoding places constraints on the unit matching system so that the paths investigated are those corresponding to sequences of speech units which are in a word dictionary (a lexicon). Lexical decoding implies that the speech recognition word vocabulary must be specified in terms of the basis units chosen for recognition. Such a specification can be deterministic (e.g., one or more finite state networks for each word in the vocabulary) or statistical (e.g., probabilities attached to the arcs in the finite state representation of words). In the case where the chosen units are words (or word combinations), the lexical decoding step is essentially eliminated and the structure of the recognizer is greatly simplified.

A confidence factor may also be formed within a confidence processor 128 for each recognized phoneme by comparing the code words of each recognized phoneme with the probability distribution of code words associated with the recognized phoneme during a training sequence and generating the confidence level based upon that comparison (at step 206). If the code words of each recognized phoneme lie proximate a low probability area of the probability distribution, the phoneme may be given a very low confidence factor (e.g., 0-30). If the code words have a high probability of being used via their location within the probability distribution, then the phoneme may be given a relatively high value (e.g., 70-100). Code words that lie anywhere in between may be given an intermediate value (e.g., 31-69). Limitations provided by the lexicon dictionary may be used to further reduce the confidence level.

As each phoneme of the phoneme sequence is recognized, the phonemes and associated code words are stored in a sequence file 136. As would be well understood, each recognized phoneme may have a number of code words associated with it depending upon a number of factors (e.g., the user's speech rate, sampling rate, etc.). Many of the code words could be the same.

Once each phoneme sequence (spoken word) has been recognized, the recognized phoneme sequence and respective confidence levels are provided to a reproduction processor 122. Within the reproduction processor 122, the words may be reproduced for the benefit of the user (at step 208). Phonemes with a high confidence factor are given a very high voice quality. Phonemes with a lower confidence factor may receive a gradually degraded voice quality in order to alert the user to the possibility of a misrecognized word(s) (at step 210).

In order to further highlight the possibility of recognition errors, a set of thresholds may also be associated with the confidence factor of each recognized phoneme. For example, if the confidence level should be above a first threshold level (e.g., 90%), then the voicing characteristics may be modified by reproduced phonemes of the recognized phoneme sequence from a model phoneme library 142. If the confidence level is below another confidence level (e.g., 70%), then the reproduced model phonemes that are below the threshold level may be reproduced within a timing processor 140 using an expanded time frame. It has been found in this regard, that lengthening the time frame of the audible recitation of the phoneme by repeating at least some code words operates to emphasize the phoneme thereby placing the user on notice that the phonemes of a particular word may not have been properly recognized.

In order to further highlight the possibility of errors, the code words associated with a recognized phoneme (and word) may be narrowed within a phoneme processor 138 based upon a frequency of use and the confidence factor. In this regard, if the code words associated with a recognized phoneme included 5 of code word “A”, 3 of code word “B” and 2 of code word “C” and the confidence factor for the phoneme were 50%, then only 50% of the associated code words would be used for the reproduction of the phoneme. In this case, only the most frequently used code word “A” would be used in the reproduction of the recognized phoneme. On the other hand, if the confidence level of the recognized phoneme had been 80%, then code words “A” and “B” would have been used in the reproduction.

If the user should decide based upon the reproduced sequence that the number is correct, then the user may activate the MAKE CALL button on the keyboard 118 of the communication device 100. If, on the other hand, the user should detect an error, then the user may correct the error.

For example, the user may activate a RESET button (or voice recognition command) and start over. Alternatively, the user may activate an ADVANCE button (or voice recognition command) to step through the digits of the recognized number. As the reproduction processor 122 recites each digit, the user may activate the ADVANCE button to go to the next digit or verbally correct the number. Instead of verbally correcting the digit, the user may find it quicker and easier to manually enter a corrected digit through the keyboard 118. In either case, the reproduction processor 122 may repeat the corrected number and the user may complete the call as described above.

Specific embodiments of a method for recognizing and correcting an input speech sequence have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of reproducing a speech sequence of a user through a communication device of the user comprising:
detecting a speech sequence from the user through the communication device;
recognizing a phoneme sequence within the detected speech sequence;
forming a confidence level of each phoneme within the recognized phoneme sequence;
audibly reproducing the recognized phoneme sequence for the user through the communication device; and
gradually highlighting or degrading a voice quality of at least some phonemes of the recognized phoneme sequence based upon the formed confidence level of the at least some phonemes.

2. The method of reproducing the speech sequence as in claim 1 further comprising reproducing the recognized phoneme sequence from a voice quality table.

3. The method of reproducing the speech sequence as in claim 1 further comprising generating the formed confidence level of the recognized phoneme from a voice quality table.

4. The method of reproducing the speech sequence as in claim 2 further comprising selecting a plurality of entries from the voice quality table to represent each phoneme of the recognized phoneme sequence.

5. The method of reproducing the speech sequence as in claim 4 wherein the step of gradually highlighting or degrading the voice quality further comprises limiting the selected entries of the voice quality table to the most frequently used entries in direct proportion to the formed confidence level.

6. The method of reproducing the speech sequence as in claim 1 further comprising comparing the formed confidence level of at least some phonemes of the phoneme sequence with a first threshold value and, when the formed confidence level of the at least some phonemes exceed the first threshold, matching the at least some phonemes with phonemes of a model phoneme dictionary and audibly reproducing the respective matched model phonemes in place of the at least some phonemes.

7. The method of reproducing the speech sequence as in claim 2 further comprising comparing the formed confidence level of at least some phonemes of the phoneme sequence with a second threshold value and when the formed confidence level of the at least some phonemes exceed the second threshold expanding a reproduction time of the audibly reproduced at least some phonemes.

8. The method of reproducing the speech sequence as in claim 1 wherein the step of detecting the speech sequence further comprises converting the detected speech sequence into a set of Mel Frequency Cepstral Coefficients(MFCC) vectors, where each phoneme of the recognized phoneme sequence is represented by the set of MFCC vectors.

9. The method of reproducing the speech sequence as in claim 8 further comprising recognizing the speech sequence using a Hidden Markov Model.

10. The method of reproducing the speech sequence as in claim 9 further comprising comparing training a database of the Hidden Markov Model to associate MFCC vectors of the user with phonemes of a model phoneme dictionary.

11. A communication device that reproducing a speech sequence of a user comprising:
a speech detector that detects a speech sequence from the user;
a Hidden Markov Model (HMM) processor that recognizes a phoneme sequence within the detected speech sequence;
a confidence processor that forms a confidence level of each phoneme within the recognized phoneme sequence;
a reproduction processor that audibly reproduces the recognized phoneme sequence for the user through a speaker of the communication device; and
a phoneme processor that gradually highlights a voice quality of at least some phonemes of the recognized phoneme sequence based upon the formed confidence level of the at least some phonemes.

12. The communication device as in claim 11 further comprising a voice quality table from which the recognized phoneme sequence are reproduced.

13. The communication device as in claim 12 further comprising a plurality of code word entries selected from the voice quality table to represent each phoneme of the recognized phoneme sequence.

14. The communication device as in claim 13 wherein the plurality of code word entries further comprises a plurality of most frequently used entries to which reproduction is limited in direct proportion to the formed confidence level.

15. The communication device as in claim 11 further comprising a first threshold level that is compared with the formed confidence level of at least some phonemes of the phoneme sequence and, when the formed confidence level of the at least some phonemes exceeds the first threshold, the at least some phonemes are matched with phonemes of a model phoneme dictionary and the respective matched model phonemes are reproduced in place of the at least some phonemes.

16. The communication device as in claim 12 further comprising a second threshold level that is comparing with the formed confidence level of at least some phonemes of the phoneme sequence with a second threshold value and when the formed confidence level of the at least some phonemes exceeds the second threshold, a reproduction time of the audibly reproduced at least some phonemes is expanded.

17. The communication device as in claim 10 wherein the step of detecting the speech sequence further comprises a set of Mel Frequency Cepstral Coefficients (MFCC) vectors into which the detected speech sequence is converted.

18. The communication device as in claim 17 wherein the HMM processor further comprises a Hidden Markov Model.

19. The communication device as in claim 18 further comprising a database of the Hidden Markov Model that is trained to associate MFCC vectors of the user with phonemes of a model phoneme dictionary.

20. The communication device as in claim 18 further comprising a cellular telephone.
